(19) United States
(12) Patent Application Publication
(10) Pub. No.: US 2011/0290148 A1
(43) Pub. Date: Dec. 1, 2011

(54) NOVEL BINDER FOR PELLETIZING MINERAL ROCK FINES

(76) Inventors: Bill Major, Sturgeon Falls (CA); Denis Major, Sturgeon Falls (CA)

(21) Appl. No.: 13/070,443

(22) Filed: Mar. 23, 2011

Related U.S. Application Data
(60) Provisional application No. 61/344,103, filed on May 25, 2010.

(51) Int. Cl. C09D 105/00

(52) U.S. Cl. 106/162.1

(57) ABSTRACT

This invention relates the use of corn steep liquor, in liquid form, as a pellet binder for mineral rock fines. The use of Corn Steep Liquor as a binder provides a durable, abrasion resistant pellet that can withstand rough handling without crumbling.

### CROSS-REFERENCE TO RELATED APPLICATIONS

This application claims the benefit of U.S. Provisional Application No. 61/344,103, filed May 25, 2010.

### FIELD OF THE INVENTION

The invention is directed to the use of Corn Steep Liquor as a pellet binder for any mineral rock fines and is directed to mineral rock fines comprising such a binder.

### BACKGROUND OF THE INVENTION

These mineral rock fines are a by-product of the mining of these minerals where they are used in the construction field, IE: Cement, concrete, building stone, cement boards, etc. during the process of quarrying these minerals fines are generated or purposely produced for a variety of applications like hydrated lime, agricultural limestone, cement and many other applications. The main purpose of this invention is the usage of Corn Steep Liquor as a low cost binder for the purpose of forming a durable abrasion resistant pellet that is durable and abrasion resistant at a low cost to the pelletizing industry.

Several binders have been introduced in the pelletizing of these mineral fines in recent years. These include various Lignosulfonates, molasses, Brewers Condensed Soluble, etc.

The present invention relates to the use of Corn Steep Liquor as a binder for mineral rock fines. Corn Steep Liquor provides a better quality pellet binder. It is an alternative to other binders that are being used. It has been found that the use of Corn Steep Liquor as a binder does not only result in a durable abrasion resistant pellet that can withstand rough handling but also has the added benefit of being a food grade environmentally friendly, inexpensive, widely available and provides a use for the Corn Steep Liquor, that at present represents a need for the Corn processing plants and the manufacture of mineral rock fines producers.

Over the past 10 years, we have seen the closure of a majority of pulp and paper mills that supply the traditional binder for this application. We anticipate the demand will grow over the next several years for a good alternative.

### SUMMARY OF THE INVENTION

The invention relates to the use of Corn Steep Liquor as a pellet binder for mineral rock fines.

### BRIEF DESCRIPTION OF THE PROCESS

The mineral rock fines pelletizing process is operated with a water/solids corn steep liquor mix as the binding agent. The Corn Steep Liquor mix with water is required to bound the dust particles and allow handling of the pellets until they are applied at the soil without degradation or breakdown.

The mineral rock fines once pelletized process produces a dry chemical product available to the general public and the agricultural industry for application on soil. Mineral rock fines are typically sold in bulk loads or 40 to 50 lbs bags. Like any fertilizer product mineral rock fines have the following properties; Non Hazardous for environmental concerns, chemical reactive with water for easy breakdown into the soil and soil Additive for pH control and improved plant growth.

For optimum utilization of the mineral rock fines into the soil the particle sizing should be as small as possible. Fine particle however are difficult to handle and distribute and are not user friendly. While ground mineral rock fines do have the above properties a dust-free property is attractive to the end-user for spreading and handling reasons. Agglomeration of mineral rock fines particles enable the minerals rock fines particles to be applied in pellet form which will quickly breakdown for assimilation into the soil.

### DETAILED DESCRIPTION OF THE INVENTION

Corn steep liquor is the first by-product of the corn wet-milling process. In that process shelled, air-cleaned corn is soaked or steeped at a temperature of 45°-50° C. for 30 to 48 hours in water initially containing about 0.1 to 0.2% sulfur dioxide. During the steeping or soaking process soluble components of the corn are dissolved in the steeping liquid, and the corn is softened thus facilitating the subsequent grinding process. The steeping liquid, sometimes called light steep water, is separated from the softened corn and concentrated by evaporation to a solids content of about 50%; the resulting concentrate is known in the art as “heavy steep water” or more commonly as “corn steep liquor”. Corn steep liquor contains dissolved minerals, carbohydrates, and corn proteins, as well as organic acids (particularly lactic acid) and modified corn proteins (amino acids and polypeptides) which result from the enzymatic activity associated with the one or more natural fermentations which take place during the corn steeping process. The composition of corn steep liquor varies with the type of corn, pH of the steeping liquid (usually 3.8-4.5), the content of the water used in the steeping process (it is often recycled from other steps of the corn-wet-milling process), steeping time and temperature. Depending on the steeping conditions, which can vary greatly from time to time in any given plant, corn steep liquor can have significant variations in relative concentrations of corn extracts and fermentation products of corn extracts. Such compositional variations can have marked effects on the physical characteristics of individual lots of corn steep liquor.

### USING CORN STEEP LIQUOR AS A PELLET BINDER

Test run were conducted with dolomitic limestone using Corn Steep Liquor as a binder comparing it to traditional binders, Calcium Lignosulfonate, Brewex and molasses. Further test were conducted using Calcitic limestone. The pelletizing test were set up with the following process equipment in order of material flow.

The pelletizing was performed in 2 steps. The material is initially processed through a Pin Mixer where the majority of the binder is applied. (The Pin Mixer sprays binder on the material, thoroughly wetting the particles, and partially agglomerates the material to prepare it for final pelletizing.) The conditioned material dropped onto a belt conveyor and transferred to a Disc Pelletizer. (The Disc Pelletizer compacts the material through tumble growth agglomeration.) Finished pellets discharged onto a belt conveyor and into a storage drum. Wet pellets were screened during each test run to determine when sampling could be done. The acceptable size is considered to be passing through 4 mesh but retained on 20 mesh.

Binder application—Each binder tested was batch mixed with water to give a similar application rate in lbs. of solids applied per lb. of dry lime processed. (All tests were set up to add binder solids at 2% by wet pellet weight and assuming 8% moisture content in pellets. The binder spray was increased or decreased until proper size pellets were seen discharging from the Disc Pelletizer). The solution components were weighed to make a 10 gallon batch and dumped in a 30 gallon polyethylene tank. The solution was pumped through a centrifugal pump with a recirculation loop back into the tank (to ensure sufficient mixing and to provide sufficient pressure (40 psi) for the Pelletizer sprays). Samples from pelletizing (off the Disc Pelletizer discharge belt conveyor) were dried, screened, and tested below.

Drying—Pellet samples were placed in a vibrating fluid bed with hot air blown through the bed of pellets to heat the product, evaporate the water, and set the binder. Partially dried samples were pulled from the pellet bed at 15, 30, 45, 60, and 75 seconds, and moisture content was measured to determine a drying curve for the product.

| | | | Dilution | |
|---|---|---|---|---|
| | | Density | rate | |
| | % Solids | (#/gal) | (% binder/ | pH - raw |
| Binder # - Type | (assumed) | (assumed) | % water) | binder |
| 1 - Sodium | 52.0 | 10.5 | 38/62 | 2.0 |
| Lignosulfonate | | | | |
| 2 - Calcium | 57.4 | 10.9 | 35/65 | 3.7 |
| Lignosulfonate | | | | |
| 3 - Sodium Lignin | 50 | 10.2 | 35/65 | 8.0 |
| 4 Corn Steep Liquor | 50 | 10.4 | 35/65 | 4 |
| 5 - Brewex | 50 | 10.0 | 40/60 | 4.8 |
| 6 - Molasses | 60 | 10.5 | 33/67 | 9.5 |
| 7 - Molasses | 73 | 11.7 | 27/73 | 5.6 |

### APPLICATION OF SAMPLE TESTS

Wet samples were tested for bulk density (lbs/cf), drop strength, compression strength, and attrition loss. Wet samples were dried in a moisture balance to determine moisture content (% water of wet weight) and drying time (for comparison of drying rate). Wet samples were dried in a fluid bed dryer to determine drying characteristics. Dry samples were tested for bulk density (lbs/cf), drop strength, compression strength, attrition loss, sieve analysis, abrasion, and solubility.

### TEST SUMMARY

### Results by Testing Parameter

The Corn Steep Liquor and the Sodium Lignin produced stronger pellets for Dolomitic lime, and the Corn Steep Liquor and Sodium based Lignins produced stronger pellets for Calcitic lime. All Dolomitic test runs pelletized at a lower moisture content than the Calcitic test runs—a conclusion from this is that the binder dose may have to be higher for Dolomitic lime applications, in direct comparison to Calcitic lime applications, to maintain the same % solids applied to the pellets. However, satisfactory pellet strengths were achieved in most cases and the tests proved that a 2% application rate is sufficient for some binders.

The 3 “best” binders are ranked below in relation to testing parameter. Due to the minute differences in some of the measured parameters and associated inaccuracies of measurements in the tests, we have taken only the top three from the test run data.

| | Best 3 - | Best 3 - |
|---|---|---|
| Testing Parameter | Dolomitic | Calcitic |
| Ease of pelletizing | 6, 3, 4 | 3, 7, 4 |
| LO moisture content | 6, 4, 5 | 1, 7, 3 |
| Drying (% moisture dried) | 3, 4, 2 | 5, 1, 4 |
| HI wet drop strength | 5, 4, 3 | 3, 1, 4 |
| HI dry crush strength | 4, 3, 7 | 2, 7, 4 |
| LO wet attrition loss | 4, 3, 2 | 1, 4, 2 |
| Sizing - % 4 by 20 mesh | 2, 5.4 | 1, 4, 5 |

From this table we suggest that binder #4 and #3 were the best overall for the Dolomitic Test Runs. Binder #1 and binder #4 were the best overall for the Calcitic Test Runs.

| Binder | | | |
|---|---|---|---|
| # | Name | Description | Source |
| 1 | Norlig 12 | Sodium | Lignotech USA, Inc. |
| | | Lignosulfonate | 100 Grand Ave. |
| | | (Hardwood) | Rothschild, WI 54474 |
| | | | 715-355-3628 |
| 2 | Norlig A | Calcium | Lignotech USA, Inc. |
| | | Lignosulfonate | |
| | | (Hardwood) | |
| 3 | Polybond | Sodium Carbonate | Northway Lignin Chemical |
| | | Lignin | 756 Coursol Road |
| | | | Sturgeon Falls, ON P2B 3J5 |
| 4 | Corn Steep | Corn Steep Liquor | ADM Corn Processing Division |
| | Liquor | | P.O. Box 29268 |
| | | | Lincoln, NE 68529 |
| 5 | Brewex | Brewers Condensed | Developing Environmental |
| | | Solubles | Resources |
| | | | P.O. Box 194 |
| | | | Elkhorn, WI 53121 |
| | | | 414-249-1750 |
| 6 | Big Chief | De-Sugarized Beet | Westway Trading Corporation |
| | | Molasses | |
| 7 | Wes Las | 79.5 Brix Cane | Westway Trading Corporation |
| | 79.5 | Molasses* | |

1. The use of Corn Steep Liquor as a pellet binder for mineral rock fines.

2. The use of claim 1 wherein the Corn Steep Liquor (CSL) is used in liquid form from 42%-55% solids.

3. The use of claim 2 wherein at least about 1% of CSL by weight of mineral rock fines is used.

4. The use of claim 3 wherein the CSL is used in a range of about 1% to about 25% by weight of mineral rock fines.

5. The use of claim 4 wherein a catalyst or a polymerization agent or viscosifier or any blend or mixture thereof is added to the CSL.

6. The use of claim 6 wherein the mixture is selected from the groups of Lignosulfonate or molasses, proteins, starches, sugars, brewers condensed soluble whey, hydrated lime, corn syrup.

7. A mineral rock fines comprising of CSL as a binder.

8. The mineral rock fines of claim 7 wherein the CSL is added as a binder.
